(19) United States
(12) Patent Application Publication
(10) Pub. No.: US 2016/0295271 A1
(43) Pub. Date: Oct. 6, 2016

(54) Time Adjustment System and Time Adjustment Method for Electronic Program Guide

(71) Applicant: Alpine Electronics, Inc., Tokyo (JP)

(72) Inventor: Manabu Fujiwara, Iwaki-city (JP)

(73) Assignee: Alpine Electronics, Inc., Tokyo (JP)

(21) Appl. No.: 15/078,037

(22) Filed: Mar. 23, 2016

(30) Foreign Application Priority Data
Apr. 3, 2015 (JP) 2015-076997

(51) Int. Cl. H04N 21/43; H04N 21/431; H04N 21/262; H04N 21/242; H04N 21/482; H04N 21/84

(52) U.S. Cl. CPC H04N 21/4302; H04N 21/4821; H04N 21/84; H04N 21/262; H04N 21/242; H04N 21/4312

(57) ABSTRACT

A clock information correction unit 15 is provided to correct the broadcast start/end times of an electronic program guide (EPG) generated in reference to the standard time. To perform this correction, the clock information correction unit 15 uses the standard time, which is the Greenwich Mean Time received by a standard time reception unit 11 of a broadcast reception device 100, and the clock time counted by an internal clock 21 of a head unit 200. The aforementioned correction is made based not on the time difference between time zones, but on the clock time of the internal clock 21. Thereby, without time zone setting based on GPS positional information or selection by a user operation, the broadcast start/end times of the EPG can be adjusted to correspond to the time of the internal clock.

### RELATED APPLICATIONS

The present application claims priority to Japanese Patent Application Serial Number 2015-076997, filed Apr. 3, 2015, the entirety of which is hereby incorporated by reference.

### BACKGROUND

1. Field of the Invention

The present disclosure relates to a time adjustment system and time adjustment method for an electronic program guide. In particular, the present disclosure is preferable for use in a system for adjusting the time of an electronic program guide defined in reference to Greenwich Mean Time (GMT) based on the time difference between the time of the electronic program guide data reception site and GMT.

2. Description of the Related Art

A function for displaying an electronic program guide (EPG) is provided as a standard feature in most broadcast reception devices that have been supplied in recent years. An EPG displays the title, broadcast start/end times, and content of a broadcast program in a tabular form and provides a user with a mechanism for readily selecting a broadcast station and making a recording reservation.

Time information of an EPG is always defined in reference to Greenwich Mean Time (GMT). In a region where there is a time difference from GMT, the local time of the region does not correspond to the time indicated by the EPG. To eliminate this difference between the times, the conventional broadcast reception device has a function for correcting the EPG time by regional time zone setting.

A video recording device with a recording reservation feature is known to have a technique for correcting a reservation information time in reference to a time difference guide that is provided in the video recording device and stores information on the time difference between the broadcast station site and a reception site (see Patent Literature 1). In another known technique, time information for correction is acquired from a broadcast signal input via a tuner, and data on the time counted by a clock count unit is compared with the time information for correction, in order to correct the clock count unit (see Patent Literature 2).

### SUMMARY

The EPG time can be corrected according to the time zone by the following two methods: 1) automatically selecting a time zone based on GPS-acquired positional information; and 2) manually selecting a time zone by a user from a list of candidate time zones.

However, method 1) is not applicable for a non-GPS broadcast reception device. In a non-GPS broadcast reception device, the EPG times (program broadcast start/end times) may be corrected by method 2). To make this correction, a user may manually open a setting window and perform an operation for selecting a time zone. It is laborious to perform this setting.

In a system provided with a function for displaying the time of an internal clock in addition to an EPG, even when the EPG time is corrected in reference to the time zone, the corrected time eventually does not correspond to the local time according to the internal clock. There can be events where the time difference set to a selected time zone differs from the actual time difference by several minutes and the time according to the internal clock differs from the exact local time according to the internal clock by several minutes. In these events, the user feels uneasy with the non-correspondence between the display times of the EPG and the internal clock.

The present disclosure is made to address the foregoing problems. The present disclosure is directed to enabling adjustment of the EPG time to the internal clock time without time zone setting based on GPS positional information or selection by a user operation.

To address the above problems, according to the present disclosure, the broadcast start/end times of an EPG generated in reference to GMT are corrected using at least the standard time, which is GMT, and the clock time counted by the internal clock.

In the above configuration of the present disclosure, correction is made based not on the time difference between time zones, but on the clock time of the internal clock. Without time zone setting based on GPS positional information or selection by a user operation, the EPG broadcast start/end times can be adjusted to correspond to the times of the internal clock.

### BRIEF DESCRIPTION OF THE DRAWINGS

FIG. 1 is a diagram illustrating an example overall configuration of a time adjustment system of an electronic program guide according to a first embodiment;

FIG. 2 is a block diagram illustrating an example functional configuration of the time adjustment system according to the first embodiment;

FIG. 3 is a block diagram illustrating a specific example functional configuration of a clock information correction unit according to the first embodiment;

FIG. 4 is a diagram illustrating one example operation performed by the clock information correction unit according to the first embodiment;

FIG. 5 is a diagram illustrating another example operation performed by the clock information correction unit according to the first embodiment;

FIG. 6 is a flowchart illustrating an example operation of the time adjustment system according to the first embodiment;

FIG. 7 is a block diagram illustrating another example functional configuration of the time adjustment system according to the first embodiment;

FIG. 8 is a diagram illustrating an example overall configuration of the time adjustment system of an electronic program guide according to a second embodiment;

FIG. 9 is a block diagram illustrating an example functional configuration of the time adjustment system according to the second embodiment;

FIG. 10 is a block diagram illustrating a specific example functional configuration of the clock information correction unit according to the second embodiment;

FIG. 11 is a diagram illustrating one example operation performed by the clock information correction unit according to the second embodiment; and

FIG. 12 is a flowchart illustrating an example operation of the time adjustment system according to the second embodiment.

### DETAILED DESCRIPTION OF THE DRAWINGS

### First Embodiment

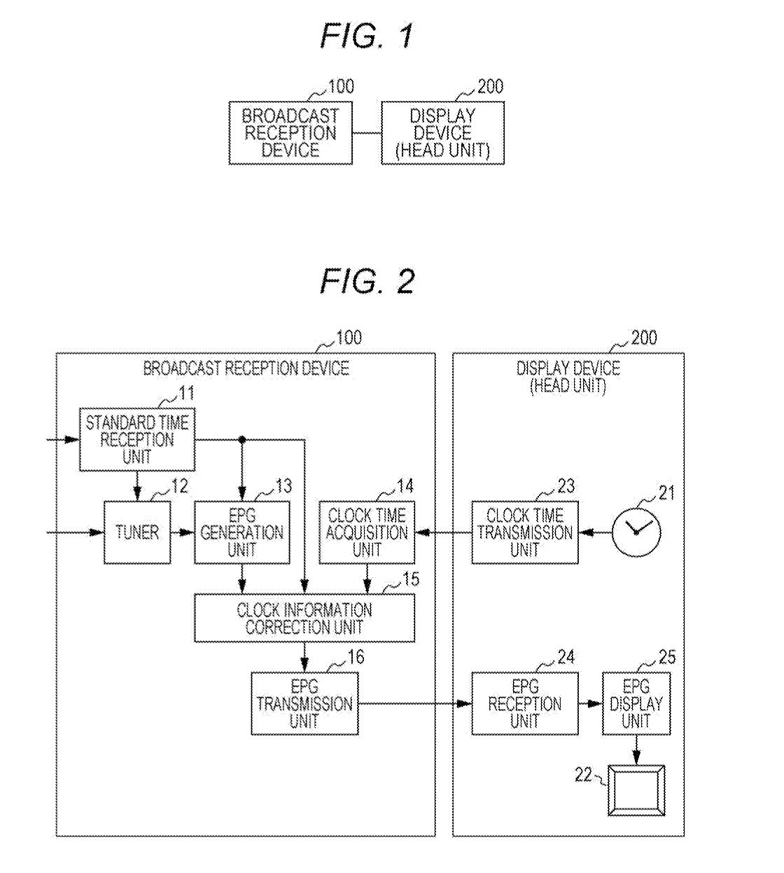

A first embodiment of the present disclosure is hereinafter illustrated in reference to the drawings. FIG. 1 is a diagram illustrating an example overall configuration of a time adjustment system of an electronic program guide according to the first embodiment. As illustrated in FIG. 1, the time adjustment system according to the first embodiment includes: a broadcast reception device 100 provided with a tuner for receiving EPG data; and a display device 200 with a clock display feature using an internal clock.

The system illustrated in FIG. 1 is, for example, an audio visual system (hereinafter referred to as “AV system”) installed on a vehicle in which the broadcast reception device 100 and the display device 200 are connected via a bus. The display device 200 outputs, from a speaker, broadcast sound received by the broadcast reception device 100 and displays a video image on the display. For example, a head unit falls into the category of the display device 200, and the display device 200 is hereinafter referred to as the “head unit 200.”

FIG. 2 is a block diagram illustrating an example functional configuration of the time adjustment system according to the first embodiment. As illustrated in FIG. 2, the broadcast reception device 100, which is one constituent element of the time adjustment system according to the first embodiment, includes: a standard time reception unit 11, a tuner 12, an EPG generation unit 13, a clock time acquisition unit 14, a clock information correction unit 15, and an EPG transmission unit 16. These functional blocks 11 to 16 can be composed of any of hardware, a DSP (Digital Signal Processor), or software.

The head unit 200, which is another constituent element of the time adjustment system according to the first embodiment, includes: an internal clock 21, a display 22, a clock time transmission unit 23, an EPG reception unit 24, and an EPG display unit 25. These functional blocks 23 to 25 can be composed of any of hardware, a DSP, or software.

The standard time reception unit 11 of the broadcast reception device 100 receives the standard time, which is GMT, from a satellite. This standard time reception unit 11 is an equivalent of a standard time acquisition unit recited in the claims. The tuner 12 receives a broadcast wave from a broadcast station. The tuner 12 also receives EPG data from a broadcast station. The EPG data is data for displaying, in a tabular form, various types of information on a broadcast program received via a broadcast wave, including the title, broadcast start/end times, and content of the broadcast program.

Based on the EPG data received by the tuner 12, the EPG generation unit 13 generates an EPG in reference to the standard time received by the standard time reception unit 11. Specifically, the EPG generation unit 13 generates an EPG in which the broadcast start/end times of each broadcast program are determined in reference to the standard time. This EPG generation unit 13 is an equivalent of an EPG acquisition unit recited in the claims.

The clock time acquisition unit 14 acquires, from the head unit 200, the clock time counted by the internal clock 21 of the head unit 200. Specifically, in the head unit 200, the clock time transmission unit 23 acquires the clock time counted by the internal clock 21 and transmits the clock time to the broadcast reception device 100. The clock time acquisition unit 14 acquires the clock time transmitted by the clock time transmission unit 23.

When a vehicle mounted with an AV system is in a region with a time difference from GMT, the standard time received by the standard time reception unit 11 of the broadcast reception device 100 is different from the clock time acquired from the head unit 200 by the clock time acquisition unit 14 due to the aforementioned time difference. In the EPG generated by the EPG generation unit 13, the broadcast start/end times of the broadcast program contains a time difference.

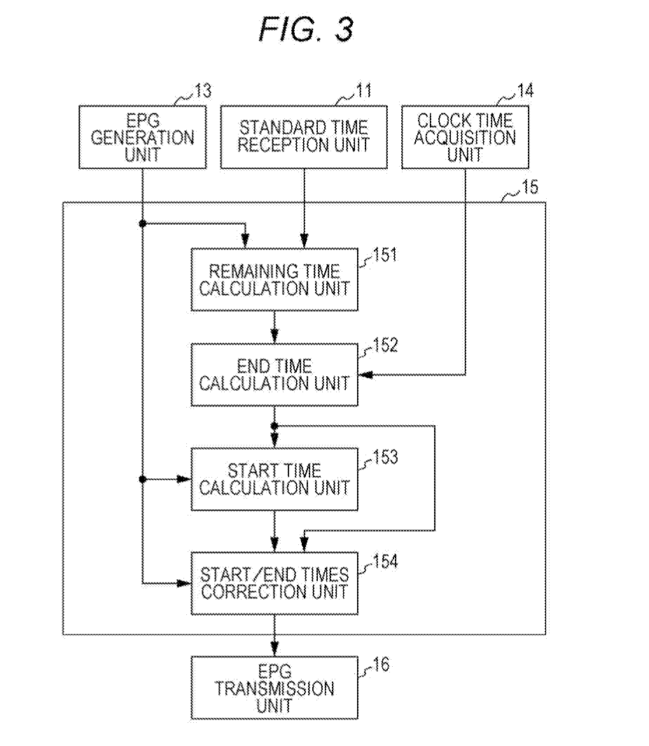

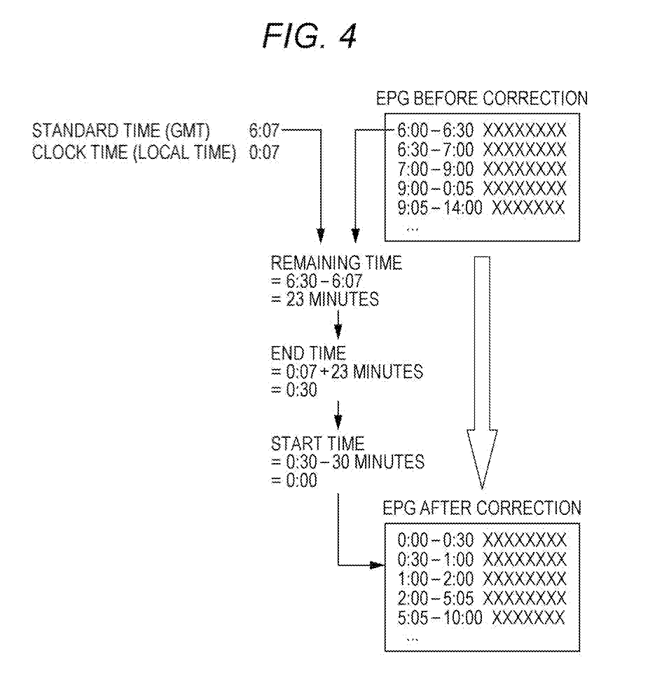

The clock information correction unit 15 uses the standard time received by the standard time reception unit 11, the clock time acquired from the head unit 200 by the clock time acquisition unit 14, and the broadcast start/end times contained in the EPG generated by the EPG generation unit 13 and corrects the broadcast start/end times of the EPG generated by the EPG generation unit 13. As a result of this correction, the clock information correction unit 15 generates an EPG determined by the broadcast start/end times in reference to the local time without a time difference. The specific processing contents for correction will be hereinafter described in reference to FIGS. 3 and 4.

The EPG transmission unit 16 transmits, to the head unit 200, an EPG in which the broadcast start/end times are corrected by the clock information correction unit 15. The EPG reception unit 24 of the head unit 200 receives the EPG transmitted by the EPG transmission unit 16 of the broadcast reception device 100—in other words, the EPG in which the broadcast start/end times are corrected by the clock information correction unit 15. The EPG display unit 25 displays, on the display 22, the EPG received by the EPG reception unit 24.

FIG. 3 is a block diagram illustrating a specific example functional configuration of the clock information correction unit 15 according to the first embodiment, and FIG. 4 is a diagram illustrating one example operation performed by the clock information correction unit 15. A functional configuration of the clock information correction unit 15 is as illustrated in FIG. 3. Specifically, the clock information correction unit 15 includes a remaining time calculation unit 151, an end time calculation unit 152, a start time calculation unit 153, and a start/end times correction unit 154. The operations of these features are hereinafter illustrated in reference to FIG. 4.

Based on the standard time received by the standard time reception unit 11 and the broadcast start/end times of an EPG generated by the EPG generation unit 13 in reference to the standard time, the remaining time calculation unit 151 calculates the remaining time of a broadcast program currently being received. The example illustrated in FIG. 4 is where: the standard time received by the standard time reception unit 11 of the broadcast reception device 100 is 6:07; the clock time (local time) counted by the internal clock 21 of the head unit 200 is 0:07; the time difference is six hours late in reference to GMT; and a broadcast program whose time is 6:00-6:30 in the EPG generated by the EPG generation unit 13 is currently being received. In this case, the remaining time calculation unit 151 calculates the remaining time of the broadcast program currently being received as follows: 6:30-6:07=23 minutes.

The end time calculation unit 152 adds the remaining time, which is calculated by the remaining time calculation unit 151, to the clock time acquired from the head unit 200 by the clock time acquisition unit 14. Thereby, the end time calculation unit 152 calculates the broadcast end time in reference to the local time of the broadcast program currently being received. In the example of FIG. 4, the end time calculation unit 152 adds the remaining time, 23 minutes, to the clock time, 0:07, and calculates that the broadcast end time of the broadcast program currently being received is 0:30.

Based on the broadcast end time calculated by the end time calculation unit 152, the start time calculation unit 153 back calculates the broadcast start time of the broadcast program currently being received. In the example of FIG. 4, the duration of the broadcast program currently being received is 30 minutes. The start time calculation unit 153 calculates that the time 0:00 is the broadcast start time of the broadcast program currently being received since the time 0:00 is 30 minutes earlier than 0:30, which is the broadcast end time calculated by the end time calculation unit 152.

In reference to the broadcast start time calculated by the start time calculation unit 153 and the broadcast end time calculated by the end time calculation unit 152, the start/end times correction unit 154 corrects the broadcast start/end times of another broadcast program. In the example of FIG. 4, the start/end times correction unit 154 corrects the broadcast start/end times of the other broadcast program in reference to the broadcast start/end times, 0:00-0:30, which is the corrected duration of the broadcast program currently being received. Specifically, as the broadcast start/end times of the broadcast program currently being received are six hours earlier, the start/end times correction unit 154 corrects the broadcast start/end times of the other broadcast program so that the broadcast start/end times are six hours earlier. Thereby, the corrected EPG time corresponds to the local time counted by the internal clock 21 of the head unit 200.

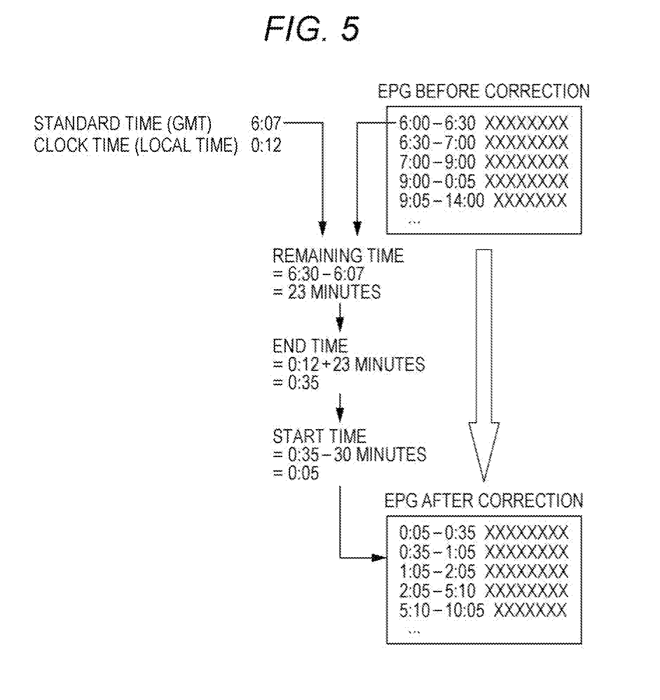

FIG. 4 illustrates an example in which the time difference is six hours. However, as illustrated in FIG. 5, even when the time difference is on a minute basis, the first embodiment is likewise applicable. FIG. 5 illustrates an example in which the time difference is six hours and five minutes. In addition, the first embodiment is likely applicable to the situation where the actual time difference is six hours and the clock time counted by the internal clock 21 is different from the exact local time on a minute basis. Specifically, the exact local time is 0:07 in the example of FIG. 5, but this example is regard as an example in which the clock time counted by the internal clock 21 is 0:12 due to the time difference of five minutes.

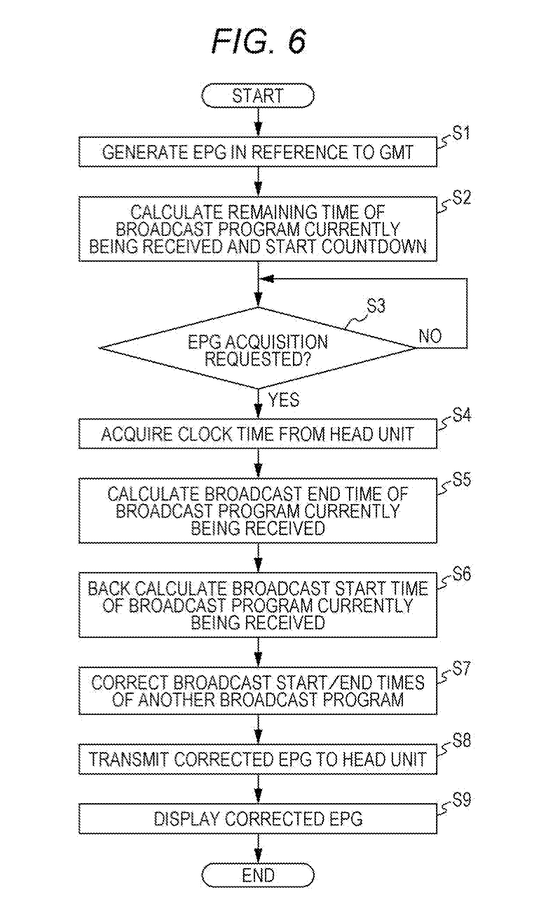

FIG. 6 is a flowchart illustrating an example operation of the time adjustment system configured as above according to the first embodiment. This flowchart of FIG. 6 starts when, for example, the power of the broadcast reception device 100 and the head unit 200 is turned on (in one example, an accessory key of a vehicle is turned on, and in turn the power of both the broadcast reception device 100 and the head unit 200 is turned on). However, the timing of starting the operation is not limited to the foregoing example.

When the broadcast reception device 100 is turned on, the standard time reception unit 11 starts reception of the standard time, and the tuner 12 starts reception of a broadcast wave and EPG data, which is not illustrated in the flowchart. Meanwhile, even when the power of the head unit 200 is not turned on, the internal clock 21 constantly counts the local time using a standby power supply device.

After the power is turned on, the EPG generation unit 13 of the broadcast reception device 100 generates an EPG in reference to the standard time that standard time reception unit 11 received based on the EPG data received by the tuner 12 (step S1). In turn, based on the standard time received by the standard time reception unit 11 and the broadcast start/end times of an EPG generated by the EPG generation unit 13, the remaining time calculation unit 151 of the clock information correction unit 15 calculates the remaining time of the broadcast program currently received and starts counting down the remaining time (step S2).

The broadcast reception device 100 determines whether an EPG acquisition request has been received from the head unit 200 (step S3). For example, when a user instructs, by the head unit 200, display of an EPG through performance of an operation on the operation window displayed on the display 22, the EPG acquisition request is transmitted from the head unit 200 to the broadcast reception device 100. When the broadcast reception device 100 has not received this acquisition request, the determination processing of step S3 is repeated.

Upon reception of the EPG acquisition request by the broadcast reception device 100 from the head unit 200, the clock time acquisition unit 14 acquires, from the head unit 200, the clock time counted by the internal clock 21 of the head unit 200 (step S4). It may be configured such that the head unit 200 transmits the clock time as well when the EPG acquisition request is transmitted from the head unit 200 to the broadcast reception device 100 and that the clock time is acquired by the clock time acquisition unit 14.

In turn, the end time calculation unit 152 adds the remaining time, which is being counted down by the remaining time calculation unit 151, to the clock time acquired by the clock time acquisition unit 14 from the head unit 200 in order to calculate the broadcast end time of the broadcast program currently being received (step S5). Based on the broadcast end time calculated by the end time calculation unit 152, the start time calculation unit 153 back calculates the broadcast start time of the broadcast program currently being received (step S6).

In turn, in reference to the broadcast end time calculated by the end time calculation unit 152 in step S5 and the broadcast start time calculated by the start time calculation unit 153 in step S6, the start/end times correction unit 154 corrects the broadcast start/end times of another broadcast program (step S7).

The EPG transmission unit 16 transmits, to the head unit 200, the EPG in which the broadcast start/end times are thus corrected by the clock information correction unit 15 (step S8). In the head unit 200, the EPG display unit 25 displays, on the display 22, the EPG transmitted by the broadcast reception device 100 (step S9). Upon completion of the foregoing step, the processing of the flowchart illustrated in FIG. 6 ends.

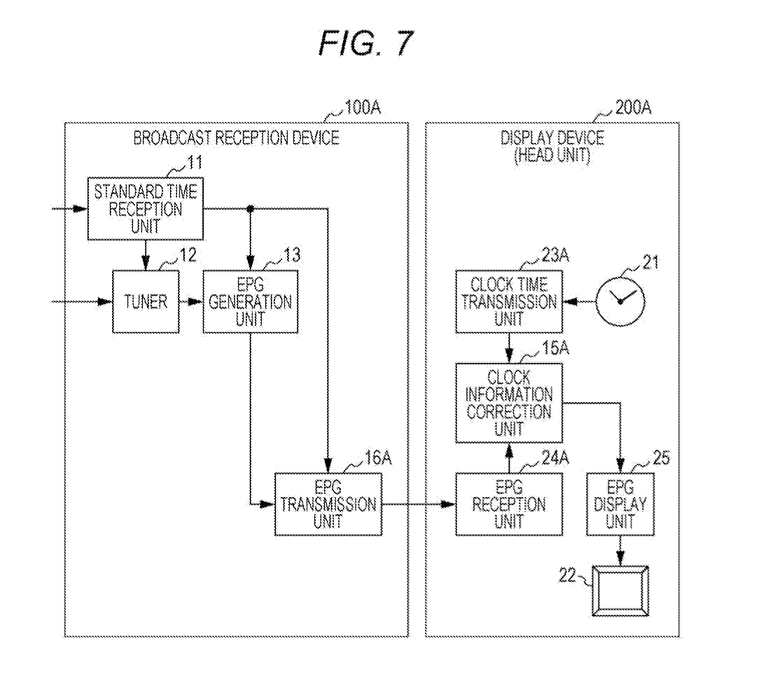

In the above embodiment, an example in which the EPG broadcast start/end times are corrected by the broadcast reception device 100 is illustrated. However, it may be configured such that this correction is performed by the head unit 200. FIG. 7 is a block diagram illustrating an example functional configuration of the time adjustment system when the broadcast start/end times are corrected by the head unit 200. The components of FIG. 7 whose reference numerals are identical to the reference numerals of the corresponding components of FIG. 2 are not described in the next embodiment to avoid repetition since the features of the above-described components of FIG. 7 are also identical to the features of the corresponding components of FIG. 2.

As illustrated in FIG. 7, the broadcast reception device 100A includes the standard time reception unit 11, the tuner 12, the EPG generation unit 13, and an EPG transmission unit 16A. Also, the head unit 200A includes the internal clock 21, the display 22, a clock time acquisition unit 23A, an EPG reception unit 24A, a clock information correction unit 15A, and the EPG display unit 25.

The EPG transmission unit 16A of the broadcast reception device 100A transmits, to the head unit 200A, an EPG generated in reference to the standard time by the EPG generation unit 13, together with the standard time acquired by the standard time reception unit 11. The EPG reception unit 24A of the head unit 200A receives the EPG and standard time transmitted by the EPG transmission unit 16A. This EPG reception unit 24A is an equivalent of the EPG acquisition unit and the standard time acquisition unit recited in the claims.

The clock time acquisition unit 23A of the head unit 200A acquires the clock time counted by the internal clock 21. The clock information correction unit 15A uses the standard time acquired from the broadcast reception device 100A by the EPG reception unit 24 (standard time received by the standard time reception unit 11), the clock time acquired from the internal clock 21 by the clock time acquisition unit 23A, and the broadcast start/end times contained in the EPG in reference to the standard time acquired from the broadcast reception device 100A by the EPG reception unit 24 and corrects the broadcast start/end times of the EPG received by the EPG reception unit 24A. The content of the correction processing performed by the clock information correction unit 15A is the same as the content of the correction processing performed by clock information correction unit 15.

The EPG display unit 25 displays, on the display 22, the EPG in which the broadcast start/end times are corrected by the clock information correction unit 15A.

As specifically illustrated above, the first embodiment uses the standard time received by the standard time reception unit 11 of the broadcast reception device 100,100A, the clock time (local time) counted by the internal clock 21 of the head unit 200, 200A, and the broadcast start/end times contained in the EPG generated in reference to the standard time in the broadcast reception device 100, 100A and corrects the broadcast start/end times of the EPG generated in reference to the aforementioned standard time.

In this configuration of the first embodiment, the clock time of the internal clock 21 equipped on the head unit 200 is used to correct the broadcast start/end times of an EPG. Thereby, without time zone setting based on GPS positional information or selection by a user operation, the broadcast start/end times of the EPG can be adjusted to correspond to the clock time (local time) of the internal clock 21. Even a non-GPS broadcast reception device can correct the broadcast start/end times. Correction of the broadcast start/end times can be performed without manual user operation for time zone setting.

### Second Embodiment

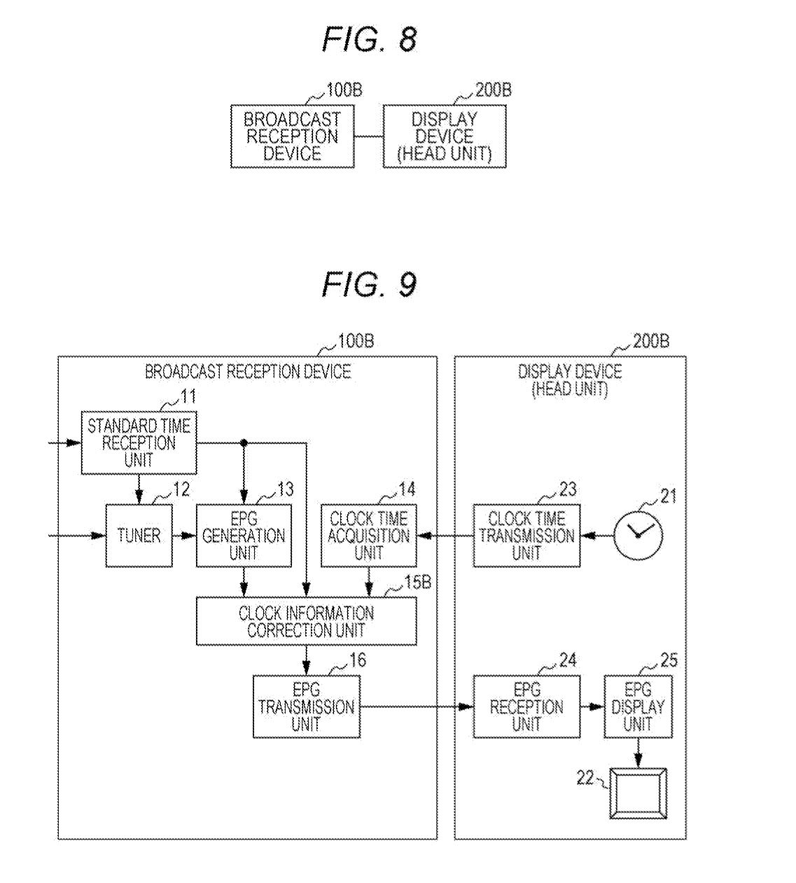

A second embodiment of the present disclosure is hereinafter illustrated in reference to the drawings. FIG. 8 is a diagram illustrating an example overall configuration of a time adjustment system of an electronic program guide according to the second embodiment. As illustrated in FIG. 8, the time adjustment system according to the second embodiment includes a broadcast reception device 100B provided with a tuner for receiving EPG data and a display device 200B with a clock display feature using an internal clock. The system illustrated in FIG. 8 is, for example, a vehicle-mounted AV system where the broadcast reception device 100B and the display device (head unit) 200B are connected via a bus.

FIG. 9 is a block diagram illustrating an example functional configuration of the time adjustment system according to the second embodiment. The components of FIG. 9 whose reference numerals are identical to the reference numerals of the corresponding components of FIG. 2 are not described in the next embodiment to avoid repetition since the features of the above-described components of FIG. 9 are also identical to the features of the corresponding components of FIG. 2. As illustrated in FIG. 9, the broadcast reception device 100B according to the second embodiment includes a clock information correction unit 15B instead of the clock information correction unit 15 of FIG. 2.

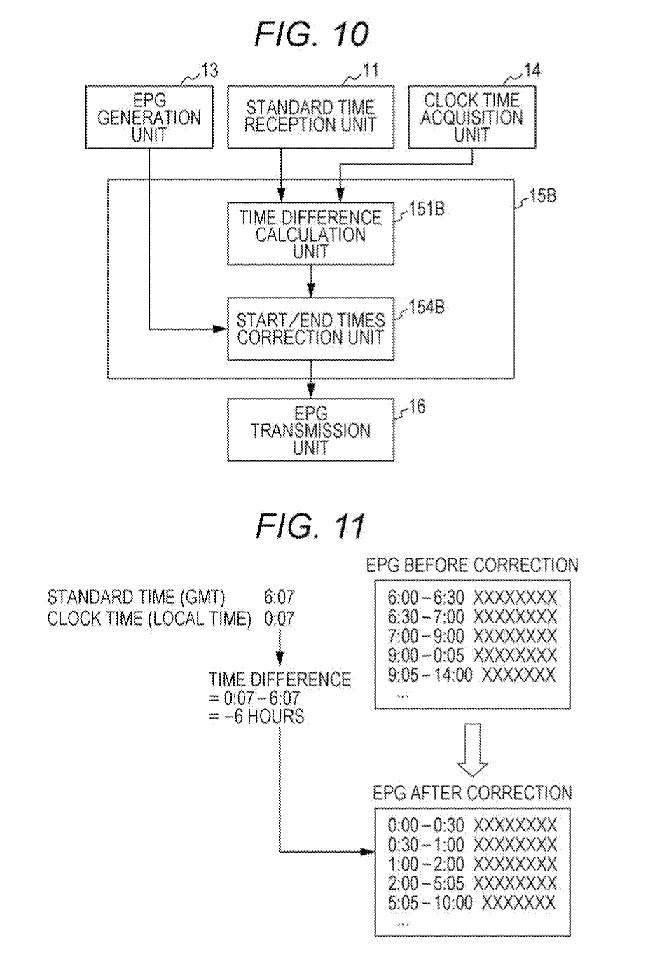

FIG. 10 is a block diagram illustrating a specific example functional configuration of the clock information correction unit 15B according to the second embodiment, and FIG. 11 is a diagram illustrating one example operation performed by the clock information correction unit 15B according to the second embodiment. The configuration of the clock information correction unit 15B is as illustrated in FIG. 10. Specifically, the clock information correction unit 15B includes a time difference calculation unit 151B and a start/end times correction unit 154B. The operations of these functional components are hereinafter illustrated in reference of FIG. 11.

As in the case of the example of FIG. 4, the example of FIG. 11 is where the standard time received by the standard time reception unit 11 of the broadcast reception device 100B is 6:07 and the clock time (local time) counted by the internal clock 21 of the head unit 200 is 0:07. This delay is due to the time difference of six hours from GMT.

The time difference calculation unit 151B calculates the time difference of the clock time, which is acquired by the clock time acquisition unit 14, from the standard time received by the standard time reception unit 11. In the example of FIG. 11, the time difference calculation unit 151B calculates the time difference of the clock time from the standard time is as follows: 0:07-6:07=−6 hours.

The start/end times correction unit 154B adds the time difference, which is calculated by the time difference calculation unit 151B, to the broadcast start/end times of a plurality of broadcast programs contained in the EPG generated in reference to the standard time by the EPG generation unit 13 and corrects the broadcast start/end times of the plurality of broadcast programs. In the example of FIG. 11, the start/end times correction unit 154B corrects the broadcast start/end times of each of the plurality of broadcast programs contained in the EPG so that the broadcast start/end times are six hours earlier. Thereby, the corrected EPG time corresponds to the local times counted by the internal clock 21 of the head unit 200.

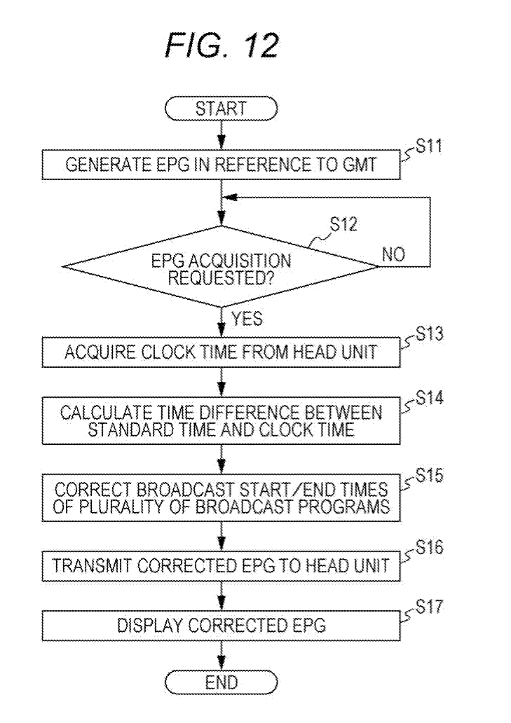

FIG. 12 is a flowchart illustrating an example operation of the time adjustment system configured as above according to the second embodiment. This flowchart of FIG. 12 starts when, for example, the power of the broadcast reception device 100B and the head unit 200B is turned on (in one example, an accessory key of a vehicle is turned on, and in turn the power of both the broadcast reception device 100B and the head unit 200B is turned on). However, the timing of starting the operation is not limited to the foregoing example.

When the broadcast reception device 100B is turned on, the standard time reception unit 11 starts reception of the standard time, and the tuner 12 starts reception of a broadcast wave and EPG data, which is not illustrated in the flowchart. Meanwhile, even when the power of the head unit 200B is not turned on, the internal clock 21 constantly counts the local time using a standby power supply device.

After the power is turned on, the EPG generation unit 13 of the broadcast reception device 100B first generates, based on the EPG data received by the tuner 12, an EPG in reference to the standard time that standard time reception unit 11 received (step S11). In turn, the broadcast reception device 100B determines whether an EPG acquisition request has been received from the head unit 200B (step S12). When the broadcast reception device 100B has not received this EPG acquisition request, the determination processing of step S12 is repeated.

Upon reception of the EPG acquisition request by the broadcast reception device 100B from the head unit 200B, the clock time acquisition unit 14 acquires, from the head unit 200B, the clock time counted by the internal clock 21 of the head unit 200B (step S13). It may be configured such that the head unit 200B transmits the clock time as well when the EPG acquisition request is transmitted to the broadcast reception device 100B and that the clock time is acquired by the clock time acquisition unit 14.

In turn, the time difference calculation unit 151B calculates the time difference of the clock time from the standard time (step S14). The start/end times correction unit 154B adds the time difference, which is calculated by the time difference calculation unit 151B, to the broadcast start/end times of the plurality of broadcast programs contained in the EPG generated in reference to the standard time by the EPG generation unit 13 in step S11 and corrects the broadcast start/end times of the plurality of broadcast programs (step S15).

The EPG transmission unit 16 transmits, to the head unit 200B, the EPG in which the broadcast start/end times are thus corrected by the clock information correction unit 15B (step S16). In the head unit 200B, the EPG display unit 25 displays, on the display 22, the EPG transmitted by the broadcast reception device 100B (step S17). Upon completion of the foregoing step, the processing of the flowchart illustrated in FIG. 12 ends.

In the above-described configuration according to the second embodiment, the broadcast start/end times of a broadcast program currently being received are not used, but the standard time and the clock time are used to correct the EPG broadcast start/end times. In this configuration according to the second embodiment, without time zone setting based on GPS positional information or selection by a user operation GPS, the EPG broadcast start/end times can be adjusted to correspond to the clock times (local times) of the internal clock 21.

According to the second embodiment, the EPG broadcast start/end times are configured to be corrected by the broadcast reception device 1008. However, it may be configured so that this correction is performed by the head unit 200B.

Also, the first and second embodiments are illustrated by exemplifying a system where the broadcast reception device 100, 100A, 100B provided with the tuner 12 for receiving EPG data and the head unit 200, 200A, 200B with a clock display feature are separate units. However, the present disclosure can be applied to an apparatus in which a broadcast reception device and a head unit are integrated.

Each of the first and second embodiments illustrates only one specific example for carrying out the present disclosure, and the scope of the present disclosure should not be thereby limited. The present disclosure can be carried out in various manners as long as an embodiment of the present disclosure does not deviate from the main object or feature of the present disclosure.

It is therefore intended that the foregoing detailed description be regarded as illustrative rather than limiting, and that it be understood that it is the following claims, including all equivalents, that are intended to define the spirit and scope of this invention.

What is claimed is:

1. A time adjustment system for an electronic program guide (EPG) comprising:
a standard time acquisition unit configured to acquire a standard time, wherein the standard time is a Greenwich Mean Time;
an EPG acquisition unit configured to acquire an EPG in reference to the Greenwich Mean Time;
a clock time acquisition unit configured to acquire a clock time, wherein the clock time is a time counted by an internal clock; and
a clock information correction unit configured to use at least the standard time acquired by the standard time acquisition unit and the clock time acquired by the clock time acquisition unit and correct broadcast start/end times of the EPG acquired by the EPG acquisition unit.

2. The time adjustment system for an electronic program guide according to claim 1, wherein the clock information correction unit comprises:
a remaining time calculation unit configured to calculate, based on the standard time and the broadcast start/end times of the EPG in reference to the Greenwich Mean Time, a remaining time of a broadcast program currently being received;
an end time calculation unit configured to add the remaining time, which is calculated by the remaining time calculation unit, to the clock time and thereby calculate a broadcast end time of the broadcast program currently being received;
a start time calculation unit configured to back calculate, based on the broadcast end time calculated by the end time calculation unit, a broadcast start time of the broadcast program currently being received; and
a start/end times correction unit configured to correct broadcast start/end times of another broadcast program based on the broadcast start time calculated by the start time calculation unit and the broadcast end time calculated by the end time calculation unit.

3. The time adjustment system for an electronic program guide according to claim 1, wherein the clock information correction unit comprises:
a time difference calculation unit configured to calculate a time difference of the clock time from the standard time; and
a start/end times correction unit configured to add the time difference, which is calculated by the time difference calculation unit, to broadcast start/end times of a plurality of broadcast programs contained in the EPG in reference to the Greenwich Mean Time and thereby corrects the broadcast start/end times of the plurality of broadcast programs.

4. The time adjustment system for an electronic program guide according to claim 1, wherein in a system comprising a broadcast reception device and a display device, the broadcast reception device provided with a tuner for receiving EPG data, the display device with a clock display feature using the internal clock,
the broadcast reception device comprises:
a standard time reception unit configured to act as the standard time acquisition unit for receiving the standard time;
an EPG generation unit configured to act as the EPG acquisition unit that, based on the EPG data received by the tuner, generates an EPG in reference to the standard time received by the standard time reception unit;
a clock time acquisition unit configured to acquire the clock time from the display device;
the clock information correction unit that uses at least the standard time and the clock time and corrects the broadcast start/end times of the EPG generated by the EPG generation unit; and
an EPG transmission unit configured to transmit, to the display device, the EPG in which the broadcast start/end times are corrected by the clock information correction unit, and the display device comprises:
a clock time transmission unit configured to transmit the clock time to the broadcast reception device;
an EPG reception unit configured to receive the EPG transmitted by the EPG transmission unit; and
an EPG display unit configured to display the EPG received by the EPG reception unit.

5. The time adjustment system for an electronic program guide according to claim 1, wherein in a system comprising a broadcast reception device and a display device, the broadcast reception device provided with a tuner for receiving EPG data, the display device with a clock display feature using the internal clock;
the broadcast reception device comprises:
a standard time reception unit configured to act as the standard time acquisition unit for receiving the standard time;
an EPG generation unit configured to act as the EPG acquisition unit that, based on the EPG data received by the tuner, generates an EPG in reference to the standard time received by the standard time reception unit; and
an EPG transmission unit configured to transmit, to the display device, the EPG generated by the EPG generation unit, together with the standard time acquired by the standard time reception unit, and the display device comprises:
an EPG reception unit configured to act as the EPG acquisition unit and the standard time acquisition unit, wherein the EPG reception unit receives the EPG and the standard time, both of which are transmitted by the EPG transmission unit;
the clock time acquisition unit configured to acquire the clock time;
the clock information correction unit configured to use at least the standard time acquired by the EPG reception unit and the clock time acquired by the clock time acquisition unit and correct the broadcast start/end times of the EPG received by the EPG reception unit; and
an EPG display unit configured to displays the EPG in which the broadcast start/end times are corrected by the clock information correction unit.

6. A method of adjusting electronic program guide (EPG) time information for use in a system comprising a broadcast reception device and a display device, the broadcast reception device provided with a tuner for receiving EPG data, the display device with a clock display feature using the internal clock, the EPG time information displayed on the display device, the method comprising:
a first step of, by a standard time acquisition unit of the broadcast reception device, acquiring a standard time, wherein the standard time is a Greenwich Mean Time;
a second step of, by an EPG acquisition unit of the broadcast reception device, acquiring an EPG in reference to the Greenwich Mean Time;
a third step of, by a clock time acquisition unit of the broadcast reception device, acquiring, from the display device, a clock time counted by the internal clock of the display device; and
a fourth step of, by a clock information correction unit of the broadcast reception device, using at least the standard time acquired by the standard time acquisition unit and the clock time acquired by the clock time acquisition unit and correcting broadcast start/end times of the EPG acquired by the EPG acquisition unit.

7. A method of adjusting electronic program guide time information for use in a system comprising a broadcast reception device and a display device, the broadcast reception device provided with a tuner for receiving EPG data, the display device with a clock display feature using the internal clock, the EPG time information displayed on the display device, the method comprising:
a first step of, by a standard time acquisition unit of the display device, acquiring a standard time from the broadcast reception device, wherein the standard time is a Greenwich Mean Time;
a second step of, by an EPG acquisition unit of the display device, acquiring an EPG from the broadcast reception device, wherein an EPG is generated in reference to the Greenwich Mean Time;
a third step of, by a clock time acquisition unit of the display device, acquiring a clock time counted by the internal clock; and
a fourth step of, by a clock information correction unit of the display device, using at least the standard time acquired by the standard time acquisition unit and the clock time acquired by the clock time acquisition unit and correcting broadcast start/end times of the EPG acquired by the EPG acquisition unit.
